(19) United States
(12) Patent Application Publication
(10) Pub. No.: US 2021/0385509 A1
(43) Pub. Date: Dec. 9, 2021

(54) Storage System and Method for High-Correlation Data Analysis with Unified Time Mapping

(71) Applicant: Western Digital Technologies, Inc., San Jose, CA (US)

(72) Inventor: Ramanathan Muthiah, Bangalore (IN)

(73) Assignee: Western Digital Technologies, Inc., San Jose, CA (US)

(21) Appl. No.: 16/891,706

(22) Filed: Jun. 3, 2020

(51) Int. Cl. H04N 21/2387; H04N 21/232; H04N 21/242; H04N 21/43; H04N 21/4335

(52) U.S. Cl. CPC H04N 21/2387; H04N 21/232; H04N 21/4335; H04N 21/4305; H04N 21/242

(57) ABSTRACT

A storage system and method for high-correlation data analysis with unified time mapping are provided. In one embodiment, a controller of a storage system is configured to receive a data stream from a host, wherein the data stream comprises a clock reference signal configured to synchronize playback of audio and video in the data stream, wherein the clock reference signal is mapped to a clock of the host; map a clock of the storage system to the clock reference signal of the data stream; tag a storage system parameter with a time stamp generated by the clock of the storage system; and send the tagged storage system parameter to the host. Other embodiments are provided.

### BACKGROUND

A storage system can be used to store data from a host. The storage system can send various storage system parameters to the host, so the host can evaluate them for trouble shooting and other purposes.

### BRIEF DESCRIPTION OF THE DRAWINGS

FIG. 1A is a block diagram of a non-volatile storage system of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the non-volatile storage system illustrated in FIG. 1A according to an embodiment.

FIG. 2B is a block diagram illustrating components of the non-volatile memory storage system illustrated in FIG. 1A according to an embodiment.

FIG. 3 is a block diagram of a host and storage system of an embodiment.

FIG. 4 is a block diagram of a host and storage system that can be used in a high-correlation data analysis method of an embodiment.

FIG. 5 is a block diagram of a host of an embodiment that provides a multi-device unified time system.

FIG. 6 is a flow chart of a method of an embodiment for high-correlation data analysis with unified time mapping.

### DETAILED DESCRIPTION

Overview

By way of introduction, the below embodiments relate to a storage system and method for high-correlation data analysis with unified time mapping. In one embodiment, a storage system is provided comprising a memory and a controller. The controller is configured to receive a data stream from a host, wherein the data stream comprises a clock reference signal configured to synchronize playback of audio and video in the data stream, wherein the clock reference signal is mapped to a clock of the host; map a clock of the storage system to the clock reference signal of the data stream; tag a storage system parameter with a time stamp generated by the clock of the storage system; and send the tagged storage system parameter to the host.

In some embodiments, the clock reference signal comprises a Program Clock Reference (PCR).

In some embodiments, the controller is further configured to parse the clock reference signal from the data stream.

In some embodiments, the controller is further configured to use the clock reference signal to synchronize playback of the audio and video in the data stream.

In some embodiments, the storage system parameter comprises one or more of the following: amount of data written, a temperature, a health metric, a garbage collection state, and a power state.

In some embodiments, the memory comprises a three-dimensional memory.

In another embodiment, a method is provided that is performed in a host in communication with a storage system. The method comprises: synchronizing a clock of the host with a timing reference configured to coordinate playback of audio and video in a data stream; sending the data stream and the timing reference to the storage system; receiving metadata from the storage system tagged with a time stamp generated by a clock of the storage system, wherein the clock of the storage system is synchronized to the timing reference of the data stream; and synchronizing the time stamp with a time domain of the clock of the host.

In some embodiments, the timing reference comprises a Program Clock Reference (PCR).

In some embodiments, the method further comprise s parsing the time stamp from the metadata.

In some embodiments, the metadata comprises a storage system parameter.

In some embodiments, the storage system parameter comprises one or more of the following: amount of data written, a temperature, a health metric, a garbage collection state, and a power state.

In some embodiments, the method further comprises receiving time-stamped metadata from at least one other storage system.

In some embodiments, the method further comprises parsing a time stamp from the time-stamped metadata from the at least one other storage system.

In another embodiment, a storage system is provided comprising: a memory; means for receiving a data stream from a host, wherein the data stream comprises a clock signal configured to synchronize playback of audio and video in the data stream; means for synchronizing a clock of the storage system with the clock signal of the data stream; means for tagging metadata with a time stamp generated by the clock of the storage system; and means for sending the tagged metadata to the host.

In some embodiments, the clock signal comprises a Program Clock Reference (PCR).

In some embodiments, the metadata comprises a storage system parameter.

In some embodiments, the storage system parameter comprises one or more of the following: amount of data written, a temperature, a health metric, a garbage collection state, and a power state.

In some embodiments, the clock signal is mapped to a clock of the host.

In some embodiments, the storage system further comprises means for parsing the clock signal from the data stream.

In some embodiments, the storage system further comprises means for using the clock signal to synchronize playback of the audio and video in the data stream.

Other embodiments are possible, and each of the embodiments can be used alone or together in combination. Accordingly, various embodiments will now be described with reference to the attached drawings.

### Embodiments

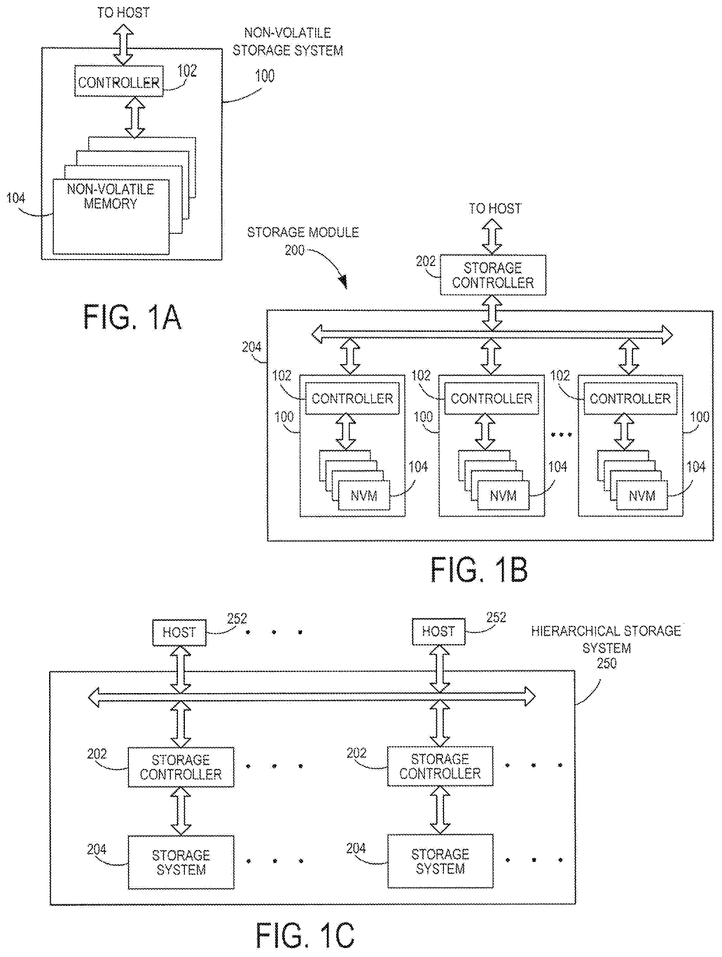

Storage systems suitable for use in implementing aspects of these embodiments are shown in FIGS. 1A-1C. FIG. 1A is a block diagram illustrating a non-volatile storage system 100 according to an embodiment of the subject matter described herein. Referring to FIG. 1A, non-volatile storage system 100 includes a controller 102 and non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104.

The controller 102 (which may be a non-volatile memory controller (e.g., a flash, resistive random-access memory (ReRAM), phase-change memory (PCM), or magnetoresistive random-access memory (MRAM) controller)) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a non-volatile memory controller is a device that manages data stored on non-volatile memory and communicates with a host, such as a computer or electronic device. A non-volatile memory controller can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. (Alternatively, the host can provide the physical address.) The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, storage system 100 may be a card based system, such as a secure digital (SD) or a micro secure digital (micro-SD) card. In an alternate embodiment, storage system 100 may be part of an embedded storage system.

Although, in the example illustrated in FIG. 1A, non-volatile storage system 100 (sometimes referred to herein as a storage module) includes a single channel between controller 102 and non-volatile memory die 104, the subject matter described herein is not limited to having a single memory channel. For example, in some storage system architectures (such as the ones shown in FIGS. 1B and 1C), 2, 4, 8 or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile storage systems 100. As such, storage module 200 may include a storage controller 202 that interfaces with a host and with storage system 204, which includes a plurality of non-volatile storage systems 100. The interface between storage controller 202 and non-volatile storage systems 100 may be a bus interface, such as a serial advanced technology attachment (SATA), peripheral component interconnect express (PCIe) interface, or double-data-rate (DDR) interface. Storage module 200, in one embodiment, may be a solid state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the storage system via a bus interface. In one embodiment, the bus interface may be a Non-Volatile Memory Express (NVMe) or fiber channel over Ethernet (FCoE) interface. In one embodiment, the system illustrated in FIG. 1C may be a rack mountable mass storage system that is accessible by multiple host computers, such as would be found in a data center or other location where mass storage is needed.

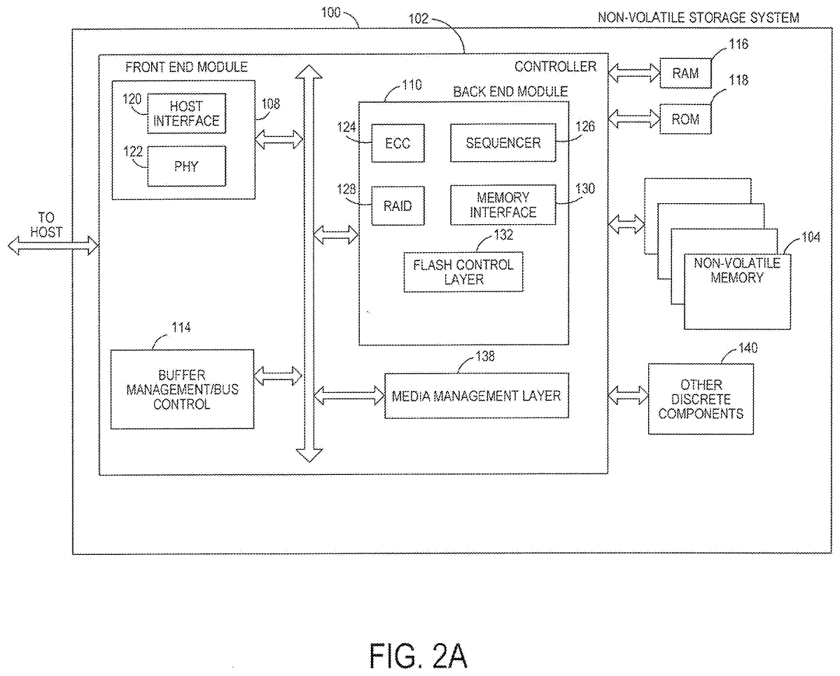

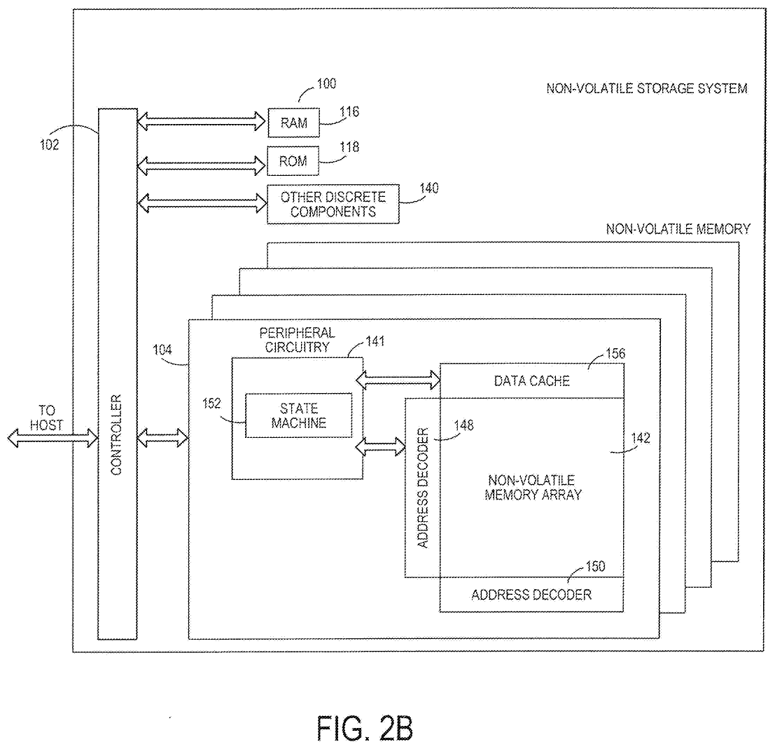

FIG. 2A is a block diagram illustrating components of controller 102 in more detail. Controller 102 includes a front end module 108 that interfaces with a host, a back end module 110 that interfaces with the one or more non-volatile memory die 104, and various other modules that perform functions which will now be described in detail. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Referring again to modules of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

The storage system 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two dimensional and/or three dimensional configuration. Non-volatile memory die 104 further includes a data cache 156 that caches data. Peripheral circuitry 141 includes a state machine 152 that provides status information to the controller 102.

Returning again to FIG. 2A, the flash control layer 132 (which will be referred to herein as the flash translation layer (FTL) or, more generally, the “media management layer,” as the memory may not be flash) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may only be written in multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P) map and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

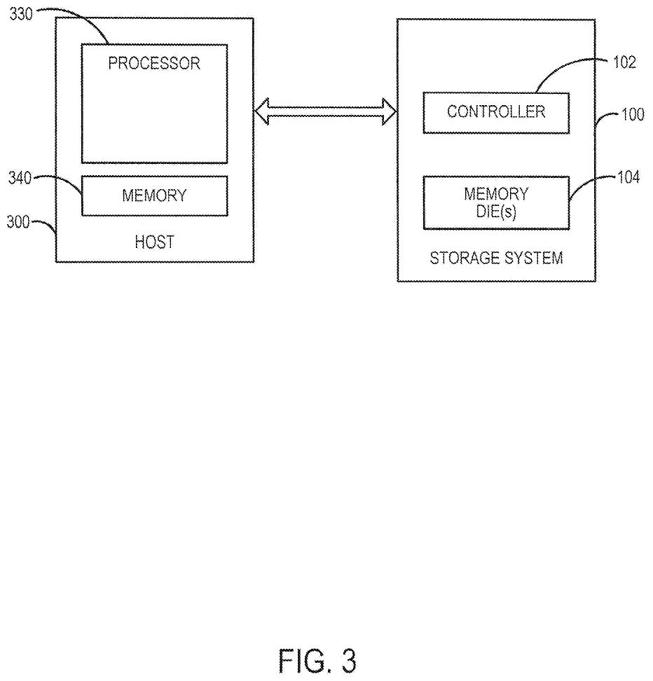

Turning again to the drawings, FIG. 3 is a block diagram of a host 300 and storage system (sometimes referred to herein as a “device”) 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises a processor 330 and a memory 340. In one embodiment, computer-readable program code stored in the host memory 340 configures the host processor 330 to read data from and write data to the storage system 100, as well as perform at least the functions described herein 100.

As mentioned above, a storage system can send various storage system parameters to the host, so the host can evaluate them for trouble shooting and other purposes. Storage system parameters, which can be presented as metadata, can include, but are not limited to, one or more of the following parameters: amount (e.g., terabytes) of data written, a temperature, a health metric, a garbage collection state, and a power state. In operation, the controller of the storage system logs these parameters at certain time intervals or in response to certain events (e.g., errors), and these logs/parameters are sent to the host for evaluation, analysis, and (potentially) action on the storage system. If the host is used with several storage systems, it can receive parameters from each of the storage systems.

In evaluating these parameters, it may be desired or necessary for the host to know the time that a value of a parameter was generated. For example, the host may need to know the time that the storage system was at the stated temperature, so it can correlate the temperature with events that were occurring contemporaneously in the host. However, the time domain of the clock of the host is usually different from the time domain of the clock of the storage system.

The following embodiments can be used to address this situation. In one embodiment, an existing time reference signal already provided from the host 300 to the storage 100 is used to synchronize the two time domains. More specifically, when the host 300 sends a data stream of audio and video data to the storage system 100, the data stream may have a clock reference signal that is used to coordinate the playback of the audio and video so they are synchronized with each other (e.g., so a person's lips are synchronized with the words being spoken by the person). One such clock reference signal is a Program Clock Reference (PCR) signal defined in the Moving Picture Experts Group (MPEG) standard. A PCR is typically a 27 MHz (or 90 KHz) system clock embedded into the transport stream for decoders to present audio and video at appropriate time. The host 300 and storage system 100, using the standard MPEG parsing stack, can easily retrieve the PCR. An advantage of using PCR is that the margin of error is relatively small given PCR's granularity (i.e., 11 micro-seconds, which is sufficient for most tagging mechanisms). While PCR will be used in these examples, it should be understood that any type of suitable timing signal can be used. Using a common reference can allow for offline synchronization of various events and logs collected from various storage systems, as will be discussed below.

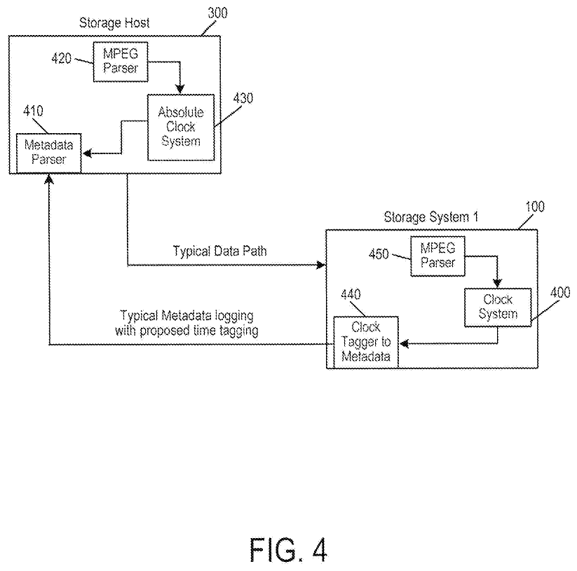

FIG. 4 illustrates the operation of one example embodiment. As shown in FIG. 4, in this example, the host 300 comprises an MPEG parser 420 (which is both a data parser and a PCR retriever), a clock (which is referred to here as the absolute clock system, since the host 300 is the master) 430, and a metadata parser 410 (to enable absolute or unified time through a first mapping). The storage system 100 comprises its own MPEG parser 450 (to enable absolute or unified time through the first mapping), a clock 400, and a metadata clock tagger 440. Some or all of these components can be in the controller 102 of the storage system 100. Also, this example assumes that the time domains of the host's and storage system's clocks 430, 400 are different.

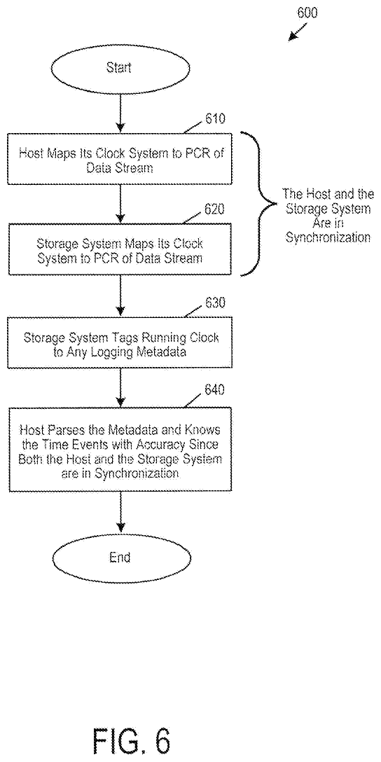

As shown in the flow chart 600 in FIG. 6, in this example, the host 300 maps its clock signal to the PCR of a data stream (act 610). This way, the host 300 can translate between a PCR value and a time in its time domain. The host 300 sends the data stream with the PCR to the storage system 100, and the storage system 100 uses its MPEG parser 450 to parse the PCR from the data stream and then maps its clock 400 to the PCR (act 620). This way, the PCR is “locked” to the time domain of the storage system 100, and the host 100 and storage system 300 are in synchronization. Next, the storage system 100 tags (time stamps) its running clock to any logging metadata (system parameter) and sends the tagged metadata to the host 300 (act 630). The host 300 uses its metadata parser 410 to parse the metadata to recover the time stamp and uses its PCR-to-host-time map to re-map/convert the time stamp value to a host-time value (act 630). So, with this double-time-mapping-scheme, the host 300 can know the time that the system parameter was generated and, based on the time, correlate the system parameter with an event that occurred at that time. In this way, an absolute time point can be located for any collected logging metadata through the remapped time system.

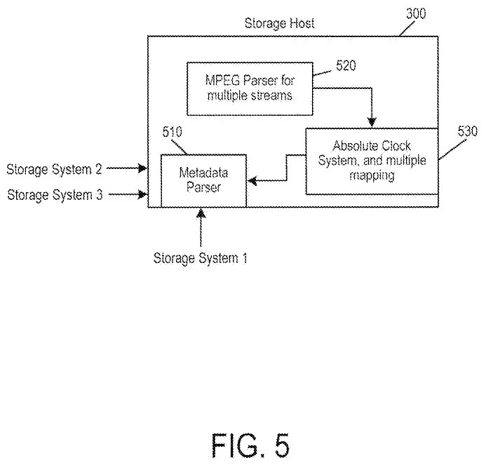

It should be noted that the host 300 can use this method with several storage systems to enable accurate comparing or analyzing data from the multiple systems. This alterative is shown in FIG. 5. Here, the metadata parser 510 of the host 300 receives time-stamped metadata from three storage systems (more or fewer storage systems can be used). The host 300 maintains clock mapping from PCRs of corresponding data streamed to multiple systems using its MPEG parser 520 and clock 530. Each of the storage systems locks to its PCR and tags its metadata with its running PCR. On receiving such data from all the storage systems, the host 300 remaps each of the time stamps to its in-house time. Each storage system thereby works under a unified time umbrella, enabling the host 300 to perform offline comparison and evaluation of the storage systems. That is, tagging metadata from multiple storage systems with an absolute or reference time allows the host 300 to better understand the state of each of the storage systems. Because of this unified time umbrella, event timelines from multiple storage systems can be compared.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

1. A storage system comprising:
a memory; and
a controller configured to:
receive a data stream from a host, wherein the data stream comprises a clock reference signal configured to coordinate playback of audio and video in the data stream so that corresponding audio and video segments in the data stream are presented at a same time, wherein the clock reference signal is mapped to a clock of the host;
synchronize a clock of the storage system to the clock reference signal of the data stream;
tag a storage system parameter with a time stamp generated by the clock of the storage system, wherein because the clock of the storage system is synchronized to the clock reference signal of the data stream, the time stamp tagged to the storage system parameter is in a time domain of the host; and
send the tagged storage system parameter to the host.

2. The storage system of claim 1, wherein the clock reference signal comprises a Program Clock Reference (PCR).

3. The storage system of claim 1, wherein the controller is further configured to parse the clock reference signal from the data stream.

4-5. (canceled)

6. The storage system of claim 1, wherein the memory comprises a three-dimensional memory.

7. A method comprising:
performing the following in a host in communication with a storage system comprising a memory:
synchronizing a clock of the host with a timing reference configured to coordinate playback of audio and video in a data stream so that corresponding audio and video segments in the data stream are presented at a same time;
sending the data stream and the timing reference to the storage system, wherein the host and the storage system use different time domains; and
receiving metadata from the storage system tagged with a time stamp generated by a clock of the storage system, wherein the clock of the storage system is synchronized to the timing reference of the data stream, and, as a result, the time stamp is in the host's time domain.

8. The method of claim 7, wherein the timing reference comprises a Program Clock Reference (PCR).

9. The method of claim 7, further comprising parsing the time stamp from the metadata.

10. The method of claim 7, wherein the metadata comprises a storage system parameter.

11. (canceled)

12. The method of claim 7, further comprising receiving time-stamped metadata from at least one other storage system.

13. The method of claim 12, further comprising parsing a time stamp from the time-stamped metadata from the at least one other storage system.

14. A storage system comprising:
a memory;
means for receiving a data stream from a host, wherein the data stream comprises a clock signal configured to coordinate playback of audio and video in the data stream so that corresponding audio and video segments in the data stream are presented at a same time;
means for synchronizing a clock of the storage system with the clock signal of the data stream;
means for tagging metadata with a time stamp generated by the clock of the storage system, wherein because the clock of the storage system is synchronized to the clock signal of the data stream, the time stamp tagged to the metadata is in a time domain of the host; and
means for sending the tagged metadata to the host.

15-20. (canceled)

21. The storage system of claim 1, wherein the storage system parameter comprises a temperature.

22. The storage system of claim 1, wherein the storage system parameter comprises a health metric.

23. The storage system of claim 1, wherein the storage system parameter comprises a garbage collection state.

24. The storage system of claim 1, wherein the storage system parameter comprises a power state.

25. The method of claim 7, wherein the storage system parameter comprises a temperature.

26. The method of claim 7, wherein the storage system parameter comprises a health metric.

27. The method of claim 7, wherein the storage system parameter comprises a garbage collection state.

28. The method of claim 7, wherein the storage system parameter comprises a power state.

29. The storage system of claim 1, wherein the controller is further configured to use the clock reference signal to coordinate playback of the audio and video in the data stream such that video of a person's moving lips is synchronized to audio of words spoken by the person.

30. The storage system of claim 1, wherein a margin of error in the clock reference signal is sufficient for a granularity needed for tagging the storage system parameter.
